(19) United States
(12) Patent Application Publication
(10) Pub. No.: US 2008/0159208 A1
(43) Pub. Date: Jul. 3, 2008

(54) METHOD AND APPARATUS FOR ALLOCATION OF SHARED SPECTRUM IN A WIRELESS COMMUNICATION SYSTEM

(75) Inventors: Kevin L. Kloker, Palatine, IL (US); Gregory J. Buchwald, Crystal Lake, IL (US); Lawrence M. Ecklund, Wheaton, IL (US); Stephen L. Kuffner, Algonquin, IL (US); Stephen N. Levine, Itasca, IL (US); S. David Silk, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/617,018

(22) Filed: Dec. 28, 2006

(51) Int. Cl. H04Q 7/00

(52) U.S. Cl. 370/329

(57) ABSTRACT

A method and apparatus for allocation of shared spectrum in a wireless communication system uses a radio frequency (RF) beacon signal that is transmitted between access points of the wireless communication system. The information content of the RF beacon signal includes an identifier of the access point that generated the signal, identifiers of clients of that access point; and identifiers of the communication channels assigned to those clients. The client identifier may include at least part of an Internet Protocol (IP) address of the client. Additionally the beacon signal may contain client attributes to enable negotiation of the sharing of available communication channels between access points and clients.

### FIELD OF THE INVENTION

The present invention relates generally to wireless communication networks.

### BACKGROUND

Some wireless communication systems, such as ad hoc communication networks for voice, video or other data, wireless sensor networks, and cognitive radio networks using incumbent spectrum (such as TV band), include a number of wireless access points. For example, in a wireless local area network (LAN) the access points may be small, personal base-stations. In this example, the purpose of an access point is to serve one or more users (clients) by supporting their wireless communication sessions and possibly connecting them to wire-line services (such as the Internet). Client-to-client communications may either go through one or more access points, or directly client-to-client using peer-to-peer communications.

At a given location, a user (a client) may be within range of a number of access points. For example, each home may have a wireless access point whose coverage overlaps with other access points in other homes in the neighborhood. For a densely populated area, such as an apartment building, a wireless access point on one floor may receive some of the transmissions of other access points on other floors. The user's designated access point is termed the target access point. Generally, a neighborhood of wireless access points exists within the range of the target. This means that other access points in the neighborhood may receive transmissions from the target, and the target may receive transmissions from neighborhood access points.

The target access point and its neighbor support multiple simultaneous communications using a shared spectrum. Therefore, some method is needed to coordinate the initial and ongoing allocation of frequency, time, and/or codes to multiplex multiple simultaneous communication sessions. This is especially critical in reuse of TV bands, for example, where non-incumbent systems (systems other than the TV channel to which the band is allocated) are expected to exhibit cognitive behavior. That is, the non-incumbent systems must sense unused spectrum and using it in a non-interfering manner. There exists a need to find a simple, efficient means for non-incumbent systems to reuse and share this spectrum.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an exemplary wireless access point of a communication system in accordance with some embodiments of the invention.

FIG. 2 is a flow chart of an exemplary method for allocation of shared spectrum in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to allocation of shared radio spectrum in a wireless communication system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of shared spectrum allocation described herein. The non-processor circuits may include, but are not limited to, a radio receiver, a radio transmitter, signal drivers, clock circuits, power source circuits, and user input devices. As such, these functions may be interpreted as a method to perform shared spectrum allocation. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Many wireless communication systems, such as ad hoc communication networks for voice, video or other data, wireless sensor networks, and cognitive radio networks using incumbent spectrum (such as TV bands), use a shared radio frequency (RF) spectrum. The systems usually include a number of wireless access points. For example, in a wireless local area network (LAN) the access points may be small, personal base-stations. In this example, the purpose of an access point is to serve one or more users (clients) by supporting their wireless communication sessions and possibly connecting them to wire-line services (such as the Internet). Client-to-client communications may either go through one or more access points, or directly client-to-client using peer-to-peer communications.

In a wireless communication system that uses shared radio frequency (RF) spectrum, each wireless access point must identify unused spectrum. This can be achieved through channel sensing, by the use of location-based tables accessed via the Internet for each region, or by other techniques that will be apparent to those of ordinary skill in the art. Once available spectrum in a neighborhood has been identified, the available spectrum is shared between clients (users) in the neighborhood.

In accordance with an embodiment of the invention, each access point in a wireless communication system transmits a beacon to enable neighboring access points to know which channels are in use. The channels may be frequency channels (in frequency division multiple access (FDMA) systems), time slots (in time division multiple access (TDMA)) systems, spreading codes (in code division multiple access (CDMA) systems) or a combination thereof. The beacons also enable clients to select a target access point by finding the strongest access point, associating with it, and beginning communication.

In one embodiment, the channels comprise frequency bands that may be shared with incumbent users. Communication within each frequency band uses FDMA, TDMA or CDMA protocols, for example, to allow multiple users to share single frequency band.

Multiple access points may select, and thus transmit beacons on, the same channel. Having overlapping coverage areas, multiple access points on the same channel may interfere with each other. Thus, there is a need for the multiple access points to negotiate how to share the same channels. For cognitive use of TV bands, for example, where the channels comprise spectrum bands, this is likely a broadband channel (e.g. 6 MHz in the U.S.A.) capable of supporting varied users and services.

In one embodiment shared radio frequency (RF) spectrum in a wireless communication system is allocated by selecting an RF band for operation of a first access point of the wireless communication system, decoding an RF beacon signal transmitted by at least one second access point of the wireless communication system operating in the selected RF band, the RF beacon signals identifying the access point, its clients and communication channels allocated to its clients and selecting communication channels to be used by the first access point dependent upon the communication channels allocated by the at least one second access point. The first access point may transmit a beacon signal that informs other access points, within communication range, of the channels it wishes to use, the identification of clients (such as least part of client's Internet address) to which the channels are to be assigned, and the identification of the first access point.

The communication channels to be used by the first access point may be selected so as not to interfere with the communication channels of the at least one second access point.

The RF band for operation of the first access point of the wireless communication system may be selected by identifying radio frequency (RF) bands that are available for communication by the first access point. This can be done, for example, by sensing a number of RF bands, determining the level of interference in each of the RF bands, and identifying RF bands with sufficiently low interference. Alternatively, the radio frequency (RF) bands may be selected by accessing a remote database of RF band allocation.

Selection of the communication channels to be used by the first access point may involve the first access point negotiating with the at least one second access point using the information in the beacon signals exchanged between the first access point and the at least one second access point.

Each access point has a unique identifier (ID) for addressability. The access point ID could be all or part of an Internet Protocol (IP) address, for example. In addition, each client associating with an access point must have, or be dynamically assigned, a unique ID in order to be addressable. A client ID could be all or part of its IPv4 or IPv6 address.

In accordance with one embodiment of the invention, each access point uses the unique client ID to allocate different channels (frequencies, time slots, and/or spreading codes) within the shared spectrum to each client so that initial communications can occur with a minimum of interference. Each access point also uses its own unique ID to allocate different channels (frequencies, time slots, and/or spreading codes) within the shared spectrum to negotiate with neighboring access points. Alternatively, a dedicated control channel could be permanently allocated for spectrum negotiation in a portion of the shared spectrum. For ongoing spectrum allocation, the target access point negotiates with neighboring access points to vary the initial allocation of channels (frequencies, time slots, and/or spreading codes) within the shared spectrum to support each client's communication session. For example, one client may need a larger allocation for a video streaming session. The target access point associated with that client requests more spectrum (frequency, time, spreading code, or some combination thereof) from the neighboring access points. Once neighboring access points agree, the target access point can use the larger allocation.

The initial and varying allocations of frequency, time, and/or spreading code can be absolute or relative to the beacon. Absolute allocation is independent of the beacon. Relative allocation is with reference to the beacon. For example, a +4 MHz relative frequency allocation could be +4 MHz relative to the beacon frequency.

In a first method for access points to negotiate spectrum sharing for client sessions, each target transmits (in its allocated spectrum) the requests for client allocations. Since neighboring access points can decode the whole broadband channel, they can receive all target requests, decode them, and respond to them.

In a second method for access points to negotiate spectrum sharing for client sessions, a dedicated control channel is used and all neighboring access points contend for communications on dedicated control channel. This method is more serial than the first method.

In accordance with some embodiments of the inventions, a system for allocating shared radio frequency (RF) spectrum in a wireless communication network includes an RF circuit operable to receive a first beacon signal from at least one first access point of the wireless communication network, a beacon decoder operable to decode the first beacon signal to recover information content, the information content including identification of clients of the at least one first points and communication channels assigned to those clients, and a channel selector operable to select communication channels of a second access point, dependent upon the information content.

The system may also include a beacon generator operable to generate a second beacon signal with information content comprising identification of clients of the second access point and communication channels assigned to those clients, in which case the RF circuit is further operable to transmit the second beacon signal.

In addition, the system may include an RF scanner operable to scan RF bands; and an RF band selector operable to select an RF band for the second access point. Alternatively, the RF band selector may select an RF band by other means, such as accessing a database of channels allocations.

Still further, the system may include a codec operable to encode communication signals of the second access point in accordance with the selected communication channels, and a data modem operable to modulate the encoded communication signals in accordance with the selected RF band.

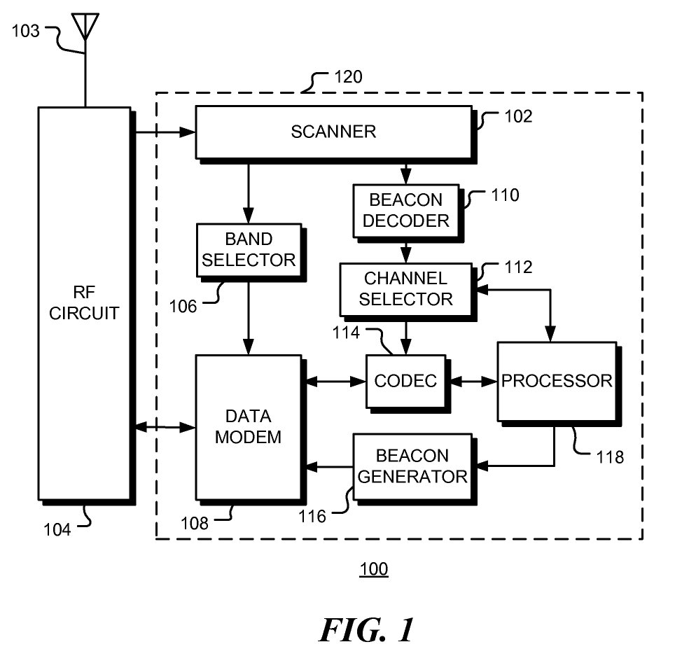

FIG. 1 is a block diagram of an exemplary wireless access point of a communication system consistent with certain embodiments of the invention. The wireless access point 100 includes a scanner 102 that receives signals from radio frequency (RF) circuit 104. The RF circuit is coupled to a radio antenna 103. The scanner is operable to sense the RF signals in each of a number of frequency bands. A band selector 106 selects a frequency band for the wireless access point and communicates the frequency band to a data modem 108 that modulates or demodulates signals at the selected frequency. For example, the scanner 102 may search a number of television channel frequency bands to determine which bands are available for use by the wireless access point. A beacon decoder 110 is operable to detect and decode beacon signals generated by other access points. Based on this information a channel selector 112 determines which channels within the selected frequency band are available for use. The selected channels are communicated to codec 114 to enable coding and decoding of signals in these channels. A beacon generator 116 is operable to generate beacon signals to inform other access points which channels it is using. A processor 118 serves to process communication signals. The processor may cooperate with the channel selector to 112 in the selection of channels and may signal the beacon generator 116 to inform it which channels are in use.

It will be apparent to those of ordinary skill in the art that the components in block 120 may be implemented in hardware or software or a combination thereof. In addition, components may be integrated in a programmed processor, application specific integrated circuit or reconfigurable circuit (such as a field programmable gate array).

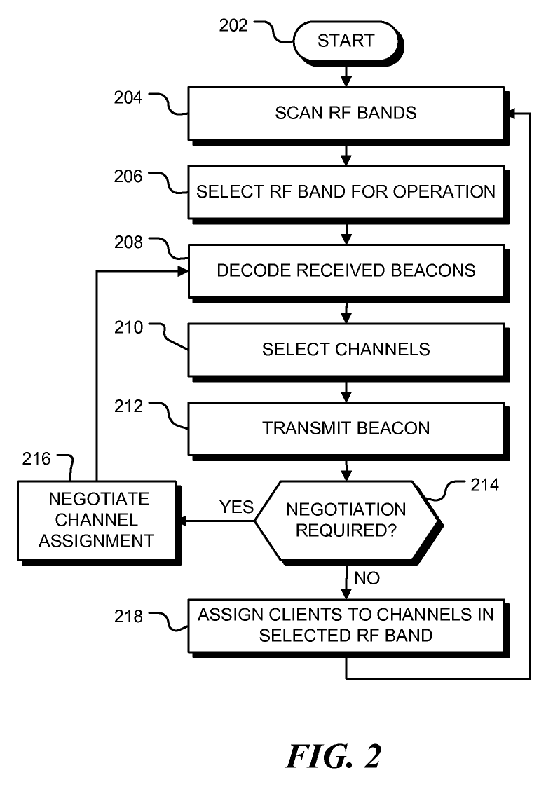

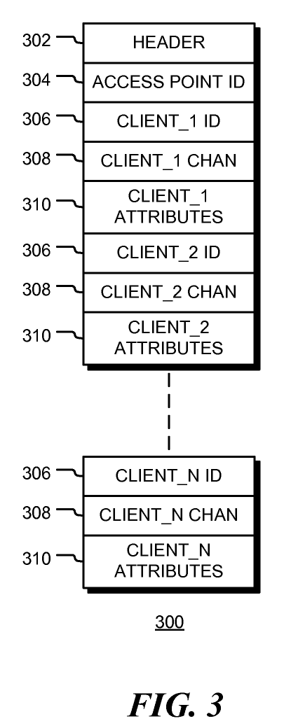

FIG. 2 is a flow chart of an exemplary method for allocation of shared spectrum in accordance with some embodiments of the invention. Following start block 202 in FIG. 2, an access point in a wireless communication system scans RF frequency bands to identify frequency bands that are available for communication at block 204. At block 206 an RF band is selected for operation of the access point. Other techniques may be used to select the RF band for operation—for example, a central database may be accessed to discover unused bands. At block 208, the access point receives and decodes beacons transmitted by other access points. These beacons identify which channels are in use by other access points and clients. At block 210, the access point selects the channels it wishes to use for communication with clients. At block 212 the access point transmits a beacon that informs other access points, within communication range, of the channels it wishes to use and the unique ID's of clients to which the channels are to be assigned, together with the access point's unique ID. A client ID may be all or part of its IPv4 or IPv6 Internet address, for example. The wireless access points can then use their unique identifiers (IDs) to allocate shared spectrum in a non-interfering way.

At decision block 214, the access determines if negotiation with other access points is required or desired to modify the allocation. If so, as depicted by the positive branch from decision block 214, the channel allocation is negotiated at block 216, using the information in the beacon signals. Once negotiation is completed, or if no negotiation is needed, as depicted by the negative branch from decision block 214, the selected channels are assigned to clients of the access point at block 218 and communication can be continued. Flow then returns to block 204 and the process is repeated. For example, if the RF band of operation becomes unavailable (due to use by an incumbent transmitter for example) a new RF is selected at block 206. Additionally, further negotiation of shared spectrum for client communication sessions may be required as clients leave or join the network or as client needs change.

At block 210 the access point assigns initial channels within the selected RF band to clients of the access point. The clients are identified by unique identifiers. At block 210, the assigned channels may then be used for communication.

FIG. 3 is a diagrammatic represent of the information content of a radio frequency (RF) beacon signal in accordance with some embodiments of the invention. The beacon signal may be transmitted from a first access point of a wireless communication system to a second access point of the wireless communication system to facilitate allocation of shared RF spectrum within the wireless communication system. Referring to FIG. 3, the information content 300 includes a header 302, an identifier 304 of the first access point, identifiers 306 of one or more clients of the first access point; and identifiers 308 of the communication channels assigned to the clients of the first access point. The header may include an identifier of one or more target access points for the beacon. The identifier 306 of the client may be at least part of an Internet Protocol (IP) address of the client, for example. The information content may also include one or more attribute 310 of a client, such as a client priority, or a client bandwidth request. The information content may be encoded within the beacon signal using techniques known to those of ordinary skill in the art.

The second access point may use the information content to allocate channels in the shared bandwidth so as to avoid interference with the operations of the first access point. Additionally the second access point may transmit a beacon to the first access point to facilitate negotiation of channel allocation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for allocation of shared radio frequency (RF) spectrum in a wireless communication system, the method comprising:
selecting an RF band for operation of a first access point of the wireless communication system;
decoding a first RF beacon signal transmitted by at least one second access point of the wireless communication system operating in the selected RF band, the first RF beacon signal having a first set of attributes that identify the access point and communication channels allocated to its clients;
selecting communication channels to be used by the first access point dependent upon the communication channels allocated by the at least one second access point;
the first access point transmitting a second RF beacon signal, to other access points within communication range, the second RF beacon signal having a second set of attributes that identify the first access point and indicate the channels the first access point wishes to use.

2. A method in accordance with claim 1, wherein the first set of attributes include an identification of a client of the second access point.

3. A method in accordance with claim 1, wherein the second set of attributes include an identification of a client to which a channel is to be assigned.

4. A method in accordance with claim 3, wherein the identification of a client comprises at least part of its Internet address.

5. A method in accordance with claim 1, wherein the communication channels to be used by the first access point are selected so as not to interfere with the communication channels of the at least one second access point.

6. A method in accordance with claim 1, wherein selecting an RF band for operation of the first access point of the wireless communication system comprises:
identifying radio frequency (RF) bands that are available for communication by the first access point.

7. A method in accordance with claim 6, wherein identifying radio frequency (RF) bands that are available for communication by the first access point comprises:
sensing a plurality of RF bands;
determining a level of interference in each of the plurality of RF bands; and
identifying RF bands with sufficiently low interference as available RF bands.

8. A method in accordance with claim 6, wherein identifying radio frequency (RF) bands that are available for communication by the first access point comprises:
accessing a remote database of RF band allocation.

9. A method in accordance with claim 1, wherein selecting communication channels to be used by the first access point dependent upon the communication channels allocated by the at least one second access point comprises:
the first access point negotiating with the least one second access point using the information in the beacon signals of the first access point and the at least one second access point.

10. A method in accordance with claim 1, wherein the communication channels comprise multiple access channels operated in accordance with a protocol selected from the group of protocols consisting of frequency domain multiple access (FDMA), time domain multiple access (TDMA) and code division multiple access (CDMA) protocols.

11. A radio frequency (RF) beacon signal containing information for transmission from a first access point of a wireless communication system to a second access point of the wireless communication system to facilitate allocation of shared RF spectrum within the wireless communication system, the information comprising:
an identifier of the first access point; and
an identifier of a communication channel assigned to a client of the first access point.

12. An RF beacon signal in accordance with claim 11, wherein the information further comprises an identifier of the client of the first access point.

13. An RF beacon signal in accordance with claim 11, further comprising at least one attribute of the client.

14. An RF beacon signal in accordance with claim 13, wherein the at least one attribute of the client comprises an attribute selected from the group consisting of a client priority and a client bandwidth request.

15. An RF beacon signal in accordance with claim 11, further comprising:
an identifier of each client of the first access point; and
identifiers of the communication channels assigned to each client of the first access point; and
attributes of each client of the first access point.

16. An RF beacon signal in accordance with claim 11, wherein the identifier of the first access point comprises at least part of an Internet Protocol (IP) address of the first access point.

17. A system for allocating shared radio frequency (RF) spectrum in a wireless communication network, the system comprising:
an RF circuit operable to receive a first beacon signal from at least one first access point of the wireless communication network;
a beacon decoder operable to decode the first beacon signal to recover information content, the information content including identification of clients of the at least one first points and communication channels assigned to those clients; and
a channel selector operable to select communication channels of a second access point, dependent upon the information content.

18. A system in accordance with claim 17, further comprising a beacon generator operable to generate a second beacon signal with information content comprising identification of clients of the second access point and communication channels assigned to those clients, wherein the RF circuit is further operable to transmit the second beacon signal.

19. A system in accordance with claim 18, further comprising:
an RF scanner operable to scan RF bands; and
an RF band selector operable to select an RF band for the second access point.

20. A system in accordance with claim 18, further comprising:
an RF band selector operable to select an RF band for the second access point.
a codec operable to encode communication signals of the second access point in accordance with the selected communication channels; and
a data modem operable to modulate the encoded communication signals in accordance with the selected RF band.
